(19) United States
(12) Patent Application Publication
(10) Pub. No.: US 2009/0167492 A1
(43) Pub. Date: Jul. 2, 2009

(54) IDENTITY VERIFICATION AND ACCESS CONTROL

(75) Inventors: Mario Madafferi, Western Australia (AU); Simon Anthony Hubble, Western Australia (AU)

Correspondence Address: LAW OFFICE OF MARK BROWN, LLC, 4700 BELLEVIEW SUITE 210, KANSAS CITY, MO, 64112, US

(73) Assignee: ENTRYDATA PTY LTD, Fremantle (AU)

(21) Appl. No.: 12/281,307

(22) PCT Filed: Feb. 27, 2007
(86) PCT No.: PCT/AU2007/000217

§ 371 Date: Aug. 29, 2008

(30) Foreign Application Priority Data
Mar. 1, 2006 (AU) 2006901019

(51) Int. Cl. G06F 7/04

(52) U.S. Cl. 340/5.82

(57) ABSTRACT

A system and method of identity verification and access control of patrons to a venue in which a biometric reader is provided for reading an identifying biological characteristic of the patron. A biometric information processing means is provided for generating a unique biometric information key for the patron based on the identifying biological characteristic read by the biometric reader. A primary database for stores the biometric information keys of newly enrolled patrons and all patrons who have previously attended the venue and been enrolled. A means is also provided to record information indicating that one or more of the biometric information keys belong to patrons that have been banned access to the venue. An access data processing means compares the biometric information key generated by the biometric information processing means with the biometric information keys stored in said primary database in order to verify both the identity of the patron and whether the patron is banned access, prior to permitting the patron access to the venue.

### FIELD OF THE INVENTION

The present invention relates to a system and method of identity verification and access control of patrons to a venue, and relates particularly, though not exclusively, to such a system and method for use in licensed venues.

### BACKGROUND OF THE INVENTION

Most licensed venues are licensed to serve alcohol to patrons as the consumption of alcohol is a normal component of the entertainment provided at such venues. However a condition of the liquor license is that no alcohol is to be served to underage patrons within the premises, which in Australia typically means anyone who is under 18 years of age. Inspectors periodically visit licensed venues to ensure that this provision of the license is being strictly complied with. Therefore most licensed venues devote significant resources, including suitably qualified Crowd Control Officers (CCOs), to screen all patrons and make appropriate identity checks to verify that no underage patrons are permitted to enter the venue.

Typical prior art identity verification and access control systems involve the CCOs asking potential patrons for some form of evidence providing proof of identity and age, such as a driver's license with photograph or some other form of identifying documentation or card. Information from the documentation may be entered into a computer system for verification purposes against an internal or publicly accessible database. This may be done manually or by electronic means. Entry and processing of the information may take some time.

There are a number of disadvantages with such prior art systems. Firstly, it is becoming increasingly common for patrons to present false identification documents. With the ready availability of sophisticated computer, printing and reproduction technology to home users, it is relatively easy to produce a counterfeit driver's license or similar document or identity card. Secondly, it takes a relatively long time to process each potential patron using such prior art systems. A popular licensed venue may have over 3000 patrons pass through its doors on a Friday or Saturday night. Even if it only takes 6 seconds to check the identity of each patron, it will take a total of 5 man hours to check all 3000 patrons. This results in long lines of people waiting outside the venue to get in, which discourages patrons from attending or returning.

The present invention was developed with a view to providing a system and method of identity verification and access control of patrons to a venue which is reliable and can substantially increase the speed at which patrons can have their identity verified and be given access to the venue. Whilst the invention will be primarily described in relation to access control for a licensed venue, it will be apparent that the system and method are equally applicable to many other situations where a degree of control is desired over the kinds of patrons who are given access to a venue, for example, people who wish to attend a football or soccer match.

References to prior art in this specification are provided for illustrative purposes only and are not to be taken as an admission that such prior art is part of the common general knowledge in Australia or elsewhere.

### SUMMARY OF THE INVENTION

According to a first aspect of the present invention, there is provided a system of identity verification and access control of patrons to a venue, the system comprising:

a biometric reader for reading an identifying biological characteristic of the patron;
biometric information processing means for generating a unique biometric information key for the patron based on said identifying biological characteristic read by the biometric reader;
a primary database for storing the biometric information keys of newly enrolled patrons and all patrons who have previously attended the venue and been enrolled;
a means to record information indicating that one or more of the biometric information keys belong to patrons that have been banned access to the venue; and
an access data processing means for comparing said biometric information key generated by said biometric information processing means with the biometric information keys stored in said primary database in order to verify both the identity of the patron and whether the patron has been banned access, prior to permitting the patron access to the venue.

Preferably, the means to record information indicating that one or more of the biometric keys belong to banned patrons comprises a secondary database in which is stored biometric keys of banned patrons.

Preferably the secondary database contains information regarding the time duration for which each patron is banned and the access data processing means compares the time duration with the time at which the patron attempts to gain access to the venue.

Advantageously, information regarding identifying documents of a patron is combined with the biometric information key of the patron to form a unique identification record that is stored in the primary database.

Preferably an enrolment terminal is provided at an access point to the venue, the enrolment terminal including the biometric reader and the biometric information processing means and the enrolment terminal is in communication with a central server on which is provided the primary database and the access data processing means.

The enrolment terminal preferably includes a means to input information regarding a patron along with the read biological characteristic of the patron to enrol the patron in the primary database. Preferably the means to input information includes a first display on which can be displayed questions for the patron to obtain said information regarding the patron.

Further, the enrolment terminal preferably includes a document scanning means to scan the identifying documents of a patron such that the scanned information is combined with the biometric information key from the biometric reader and transmitted to the central server as a unique identification record. Advantageously, a means to capture image information for each patron at the time of entry is provided. The means to capture image information may comprise a camera connected to the enrolment terminal, the camera being arranged to take a picture of each patron attempting to enter the venue via the enrolment terminal.

Preferably a review tool is provided, the review tool allowing an authorised person to review the image information of patrons entering the venue within a particular time frame and the unique identification records of those patrons stored in the primary database. The review tool may comprise software on the central server.
The review tool may include means to select one or more of the unique identification records of those patrons entering the venue within the time frame for inclusion in the secondary database.
Also, the review tool may include means to add information regarding the time duration of the ban and reason for the ban to the secondary database. Advantageously, the primary database comprises:
an alpha database in which are stored the biometric information keys of a selected number of the most recent patrons to Enter the venue; and
a beta database in which are stored the biometric information keys of all patrons entering the venue;
wherein the access data processing means compares first the generated biometric information key generated with the biometric information keys stored in said alpha database and if no match is found, compares the generated biometric information key generated with the biometric information keys stored in said beta database.
An event database may be provided in which is stored information specific to an event, and the access data processing means compares the information contained in the unique identification record of a patron with the event database information to determine whether access to the current event is permitted. The stored information in the event database may include age restrictions on the event and the access data processing means compares age information stored in the unique identification record of a patron with the age restriction.

According to a second aspect of the present invention there is provided a method of identity verification and access control of patrons to a venue, the method comprising the steps of:

reading an identifying biological characteristic of a patron;
generating a unique biometric information key for the patron based on said identifying biological characteristic;
storing the biometric information keys of newly enrolled patrons and all patrons who have previously attended the venue and been enrolled;
storing information indicating that one or more of the biometric information keys belongs to a patron that has been banned access to the venue;
comparing said unique biometric information key with the stored biometric information keys in order to verify both the identity of the patron and whether the patron is banned access, prior to permitting the patron access to the venue.

Preferably, the biometric keys belonging to banned patrons are stored in a secondary database. Further, the information regarding the time duration for which each patron is banned is stored in the secondary database and the access data processing means compares the time duration with the time at which the patron attempts to gain access to the venue.

Preferably, the method includes the step of combining information regarding identifying documents of a patron with the biometric information key of the patron to form a unique identification record that is stored in the primary database.

The method may also include the steps of displaying on a first display on the enrolment terminal, information including the results of whether a patron's identity has been verified and whether the patron has been banned access to the venue.
Preferably, the step of reading biometric information comprises scanning fingerprints. The biometric information key may then be formed by converting the scanned fingerprint into a binary number representing the unique characteristics of the ridges and meridian points of the fingerprint.
Advantageously, the method includes the step of capturing image information for each patron at the time of entry.

### The Method Also Preferably Includes:

comparing the generated biometric information key generated with the biometric information keys stored in an alpha database, in which are stored the biometric information keys of a selected number of the most recent patrons to enter the venue; and
if no match is found, comparing the generated biometric information key generated with the biometric information keys stored in a beta database in which are stored the biometric information keys of all patrons entering the venue.
The method may also include the step of storing information specific to an event in an event database and comparing the information contained in the unique identification record of a patron with the event database information to determine whether access to the current event is permitted.
Preferably, the method of identity verification arid access includes the step of storing membership information in the primary database for enrolled patrons and this membership information is accessed by the access data processing means when the patron enters the venue via the enrolment terminal.
Further, survey questions may be displayed on the enrolment terminal and the answers to the survey questions provided by the patron then stored along with information contained in the primary database about the patron.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the system and method of identity verification and access control of patrons to a venue, given by way of example only, with reference to the accompanying drawings, in which:

FIG. 1 is a functional block diagram of a preferred embodiment of the system of identity verification and access control in accordance with the present invention;

FIG. 2 illustrates a preferred embodiment of an enrolment terminal employed in the system of FIG. 1;

FIG. 3 is a flow chart of the normal steps involved in verifying the identity and permitting entry to a venue in accordance with a preferred embodiment of the method of identity verification and access control of the present invention; and

FIG. 4 is a flow chart of the steps involved in enrolling a patron in accordance with a preferred embodiment of the method of identity verification and access control of the present invention.

### DETAILED DESCRIPTION OF PREFERRED EMBODIMENTS

### System of Identity Verification and Access Control

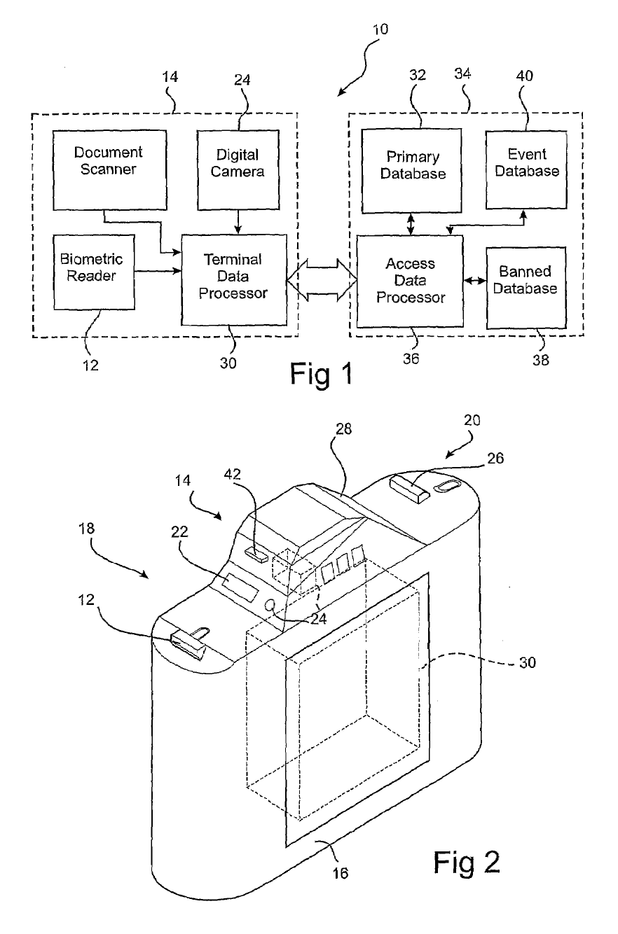

A preferred embodiment of the system 10 of identity verification and access control in accordance with the invention, as illustrated in FIGS. 1 and 2, comprises a biometric reader 12 for reading an identifying biological characteristic of a patron. In the preferred embodiment the biometric reader is a fingerprint reader 12, however it will be understood that any other suitable biometric reader could be employed, for example, a reader based on retinal or iris scanning or face recognition. A suitable fingerprint reader 12 is that produced by Crossmatch Inc, with a resolution of 500 dpi. The fingerprint reader 12 is preferably housed in an enrolment terminal 14 located at the entrance to the venue for enrolling patrons in the system 10.

The enrolment terminal 14 typically comprises an appropriately stylised casing 16, as illustrated in FIG. 2, having a Front end 18 facing a patron while he/she waits to be enrolled, and a back end 20 facing an enrolment officer while he/she supervises the enrolment process. The fingerprint reader 12 is built-in to the front end 18 of the terminal. A small video screen 22 is also provided at the front end 18 of the terminal to provide the patron with visual cues during the enrolment process. Preferably the terminal 14 also includes a camera 24 for capturing a digital image of the patron at the time of enrolment in the system. The USB camera 24 is housed in the casing 16 at the front end 18 of the terminal 14, and can be used to capture one or more still images and/or a few seconds of video of the patron during the enrolment process. Preferably the terminal 14 further comprises a document scanner 26 at the back end 20, for scanning a driver's license or other proof of identity document. A second video touch screen 28 is typically provided at the back end 20 of the terminal 14 to advise the enrolment officer of the results of each step in the enrolment process.

The system 10 further comprises a first terminal data processor 30, typically housed in the terminal 14, for generating a unique biometric information key for the patron based on the identifying biological characteristic read by the fingerprint reader 12. The data processor 30 scans the fingerprint and converts the image into a 300 byte binary number that represents the unique characteristics of the ridges and meridian points of the fingerprint. The actual image of the fingerprint is discarded and only this binary number is stored as the unique biometric information key for the patron.

The terminal data processor 30 also typically processes the information scanned by the document scanner 26 from the proof of identity document to produce a document identification record. This document identification record may be combined with the biometric information key to produce a unique identification information record for the patron. The data processor 30 preferably includes optical character recognition (OCR) software for converting printed matter on the proof of identity document into machine-readable characters that form part of the document identification record. Preferably the unique identification information records are stored in a primary database 32.

The primary database 32 for storing the biometric information keys of newly enrolled patrons and all patrons who have previously attended the venue and been enrolled is typically associated with a central server 34. In the preferred embodiment of the invention the primary database 32 is partitioned into an alpha database and a beta database. The alpha database holds the unique identification information records for a predetermined maximum number of the most recently enrolled patrons, say 60,000 patron records, and the beta database holds the unique identification information records for a predetermined maximum number of all other patrons who have previously enrolled, say 500,000 patron records. Typically the alpha database is accessed first during the enrolment process.

Typically the system also includes a venue Crowd Control Officer (CCO) and manager database (not illustrated). All CCOs and managers of the venue are enrolled in the venue staff database at the time of their employment or installation of the system, including one or more enrolment officers.

The central server 34 is provided with a second access data processor 36 for comparing the biometric information key generated by the terminal data processor 30 with the biometric information keys stored in the primary database 32 in order to verify the identity of the patron prior to permitting the patron access to the venue. This access data processor 36 preferably includes a fingerprint matching engine for rapidly comparing a newly generated binary number with the binary numbers stored in the primary database 32 as the unique biometric information keys for each patron.

The system 10 also includes a means to indicate that one or more of the biometric information keys belongs to a patron that has been banned access to the venue. The means comprises a secondary database 38 for storing biometric information keys of patrons who have been banned from access to the venue. The access data processor 36 also compares the biometric information key generated by the terminal data processor 30 with the biometric information keys stored in the secondary database 38. If a match is found the enrolment officer is warned via the video screen 28 that the individual concerned has been banned from that venue. The conditions and duration of the ban will also be displayed on the screen 28.

The enrolment terminal 14 also includes a means to search the primary database based on information other than the biometric information key. For example, the CCO may search through primary database records based on the name or partial name information, date of birth, driver's license number or any other stored information. This search function would be of assistance when a patron has enrolled previously but their record in the primary database is not found when their fingerprint is scanned. The fingerprint may not have scanned correctly at the original enrolment resulting in no match on the database search. The system also has a means to correct the stored biometric information key by re-reading the information, when the correct record in the primary database is found.

The central server 34 preferably also comprises an event database 40 for storing information pertaining to an event occurring in the venue. The access data processor 36 also checks the event database 40 for special access requirements pertaining to the event prior to permitting the patron access to the venue. For example, if the event is an underage event, then only patrons under the age of 18 may be given access to the venue. In addition, or alternatively, the event may be a ticketed event in which case access will be denied to any patron unable to present a valid ticket to the CCOs. The event database 40 may also be used to facilitate various promotional activities and/or market research activities on behalf of sponsors using de-identified data.

Preferably the enrolment terminal 14 is also provided with a small printer 42 for printing a hardcopy receipt of the patron's enrolment details, or other information pertaining to the event or to the venue. The printer 42 is preferably housed in the front end 18 of the terminal casing 16 and has an automatically fed paper roll.

The enrolment terminal 14 is preferably networked with the central server 34 via a hard-wired network or a wireless network. Typically multiple terminals 14 are served by a single central server 34, each terminal having an individual identification number and a venue location identification number. The same central server 34 may serve multiple venues owned by different licensees. Separate databases are kept for each venue and/or licensee. Each enrolment terminal 14 is capable of downloading a partial temporary copy of the various databases held in the central server 34 pertaining to that venue. This helps to speed-up the enrolment process, particularly for those venues located in remote places relative to the location of the central server 34. Throughout the day or evening of the event, while the enrolment terminal 14 is in use, any changes in the temporary copies of databases at the terminal 14 are mirrored in the original databases stored at the central server 34, and vice versa. At the end of each day when the venue closes and the enrolment terminal is logged off, all local copies of the databases are deleted from memory in the terminal 14 for security reasons.

The system 10 also may include membership information in the primary database. The membership information indicates for each patron whether they are members of one or more membership packages offered by the venue. On accessing the venue via the enrolment terminal, the access data processing means checks the membership status of the patron in the primary database. The results are displayed on the second display on the enrolment terminal to notify that the patron is entitled to benefits associated with the membership package.

The system 10 may also include a means to run market surveys. The survey queries may be displayed on the first display of the enrolment terminal if a patron wishes to participate in the survey. By placing their finger on the fingerprint reader at the time of commencing the survey, the system 10 can store the survey results with information contained in the primary database regarding the patron, such as age, sex and address.

Further, the system 10 may also include means to store information regarding whether a patron has purchased tickets to the event. The tickets may, for example, be purchased online with details of the purchaser stored such that the details are accessible by the system 10. The patron can then simply collect their tickets by undergoing the verification process at the enrolment terminal.

### Patron Enrolment Process

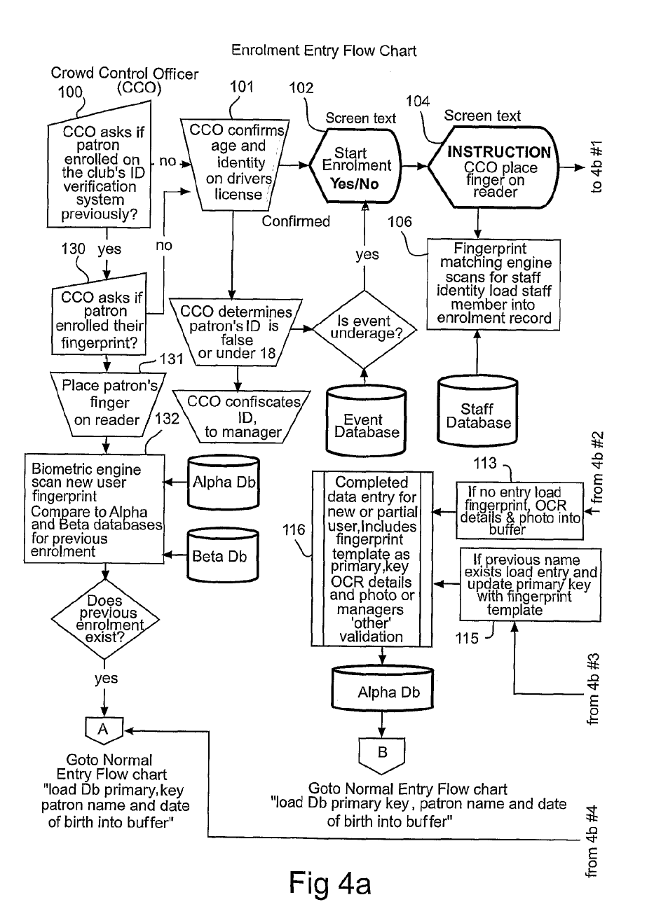

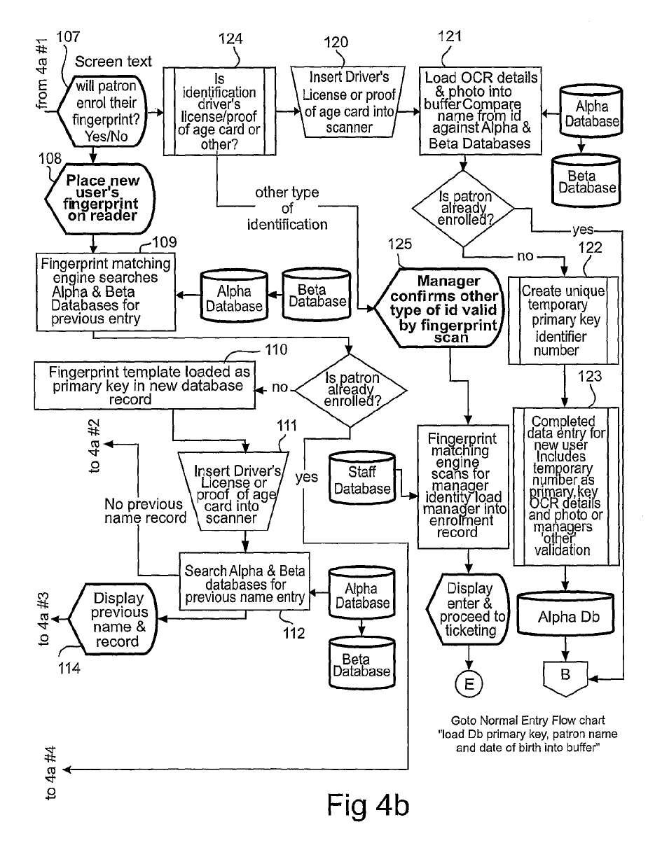

A preferred embodiment of the enrolment process for new patrons will now be described with reference to FIGS. 1, 2 and 4. A trained crowd control officer (CCO) asks the patron if they have been enrolled on the club's ID verification system previously [100]. The CCO then inspects the patron's driver's license or other photo id and confirms to the best of their ability that the identification is accurate, valid and true [101]

The CCO selects the key “Enrol” on the terminal touch screen 28 [102]. The screen changes to the enrolment mode and requests the CCO to place their index finger on the fingerprint reader 12 [104]. On detecting the finger placement the system software processes the fingerprint read, to verify authority to enrol [106]. The database against which the fingerprint matching software compares is the venue staff database. The name of the enrolment officer is the first record to be loaded into the enrolment buffer. The enrolment buffer is held in the RAM of access data processor 36. During this time the patron display screen 22 displays “Enrolling”.

The enrolment display screen 28 then prompts the CCO to ask the patron if they would like to enrol their fingerprint on the system [107]. If the patron says “Yes”, the enrolment display prompts the CCO to ask the patron to place their right hand index finger on the fingerprint reader 12 [108]. At the same time the patron display screen 22 displays the message ‘Place finger here’ with downward arrows. When the patron places their finger on the fingerprint reader 12 the terminal processor 30 verifies that a quality read has been acquired and generates a binary encoded number representational of the fingerprint (finger PIN template). The fingerprint matching engine searches the alpha and beta databases for any previous matching entries [109]. If not matching entry is found the binary encoded number is loaded into the enrolment buffer as the primary key [110].

The enrolment display screen 28 then prompts the CCO to insert the new patron's driver's license into the document scanner 26 [111]. The scanner 26 will scan the document and the terminal processor 30 will convert the document image (OCR) into machine readable format (ASCII) and search the alpha and beta databases for any matching previous name entry [112]. If no match is found, the details are forwarded to access processor 36 for loading into the enrolment buffer [113]. If a previous entry is found, this entry is displayed [114] and may then be loaded into the buffer together with an updated primary key based on the most recently acquired fingerprint template [115].

During the reading of the fingerprint a digital image of the patron's face is acquired by the USB camera 24. The image is filed with the driver's license facial image (obtained from the document scanner 26). When reading is complete the patron display 22 displays the message “Thank you, processing” or words to that effect.

The completed unique identification information record for the new patron is compiled from the binary encoded number (fingerprint template) as primary key, the OCR details and photo or manager's ‘other’ validation [116]. This unique identification information record is then stored in the alpha database.

The enrolment display screen 28 then prompts the CCO with the following message: “What is the sex of the enrolee—MALE or FEMALE?” The CCO then selects the appropriate sex via the touch screen 28. The enrolment display screen 28 then displays to the CCO “Ask patron ‘Would you like to be kept up to date with club events and promotion?’”. The CCO enters “YES” or “NO” via the touch screen 28. If the CCO enters “YES” then the enrolment display screen 28 displays—“Ask patron to place finger on reader to confirm.” The patron display screen 22 then displays “Place finger here” with arrows. The fingerprint need not be processed but it is necessary to detect and confirm that the action took place. The printer 42 then prints out a text notice addressed to the enrolee's name, advising of Club Privacy Policy and indicating their acceptance to participate in promotions. The patron display screen 22 then displays “Thank you for enrolling. Please take your Privacy Statement” or words to that effect.

The CCO screen then displays “Enrolment complete” and the next line “Enrol another?” with a button for “Yes” and “No”. If “No” is selected the display returns to the normal screen. If “Yes” the display returns to the primary enrolment screen.

If at the commencement of the enrolment process [107] the patron indicates they do not wish to have their fingerprint enrolled, enrolment proceeds directly with scanning of their driver's license or other proof of identity document [120]. The scanner 26 will scan the document and the terminal processor 30 will convert the document image (OCR) into machine readable format (ASCII) and search the alpha and beta databases for any matching previous name entry [121]. If the patron is not already enrolled a temporary primary key ID number is created [122] (in place of the fingerprint template), and this is used to compile the complete unique identification information record for the new patron, including OCR details and photo or manager's ‘other’ validation [123]. If the proof of identity is some other form of identification [124], then the manager may confirm that this other type of identification is valid by fingerprint scan [125].

If a patron thinks they have previously enrolled [100], the CCO asks the patron if they have previously enrolled their fingerprint [130]. If not, the CCO confirms the age and identity of the patron [101] and follows the normal fingerprint enrolment procedure. If the patron thinks they have previously enrolled their fingerprint, the CCO requests the patron place their finger on the fingerprint reader 12 [131]. The patron's fingerprint is read and the biometric engine converts the scan into a binary encoded number representational of the fingerprint (fingerprint template). The fingerprint matching engine searches the alpha and beta databases for any previous matching entries [132]. If a previous enrolment does indeed exist, no further action is required of the enrolment officer, and the patron may proceed as per the normal entry mode.

### Method of Identity Verification and Access Control

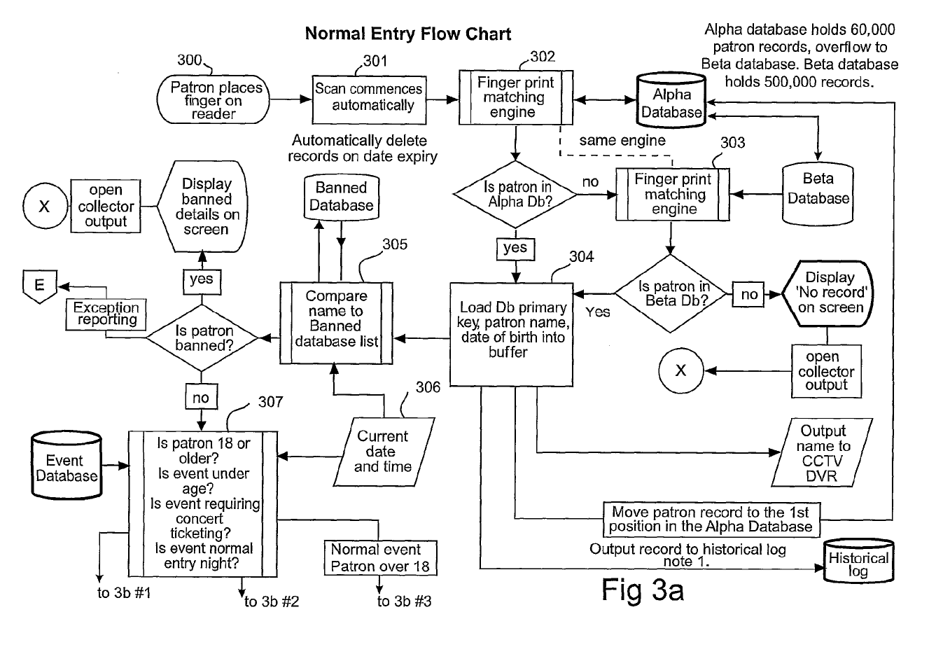

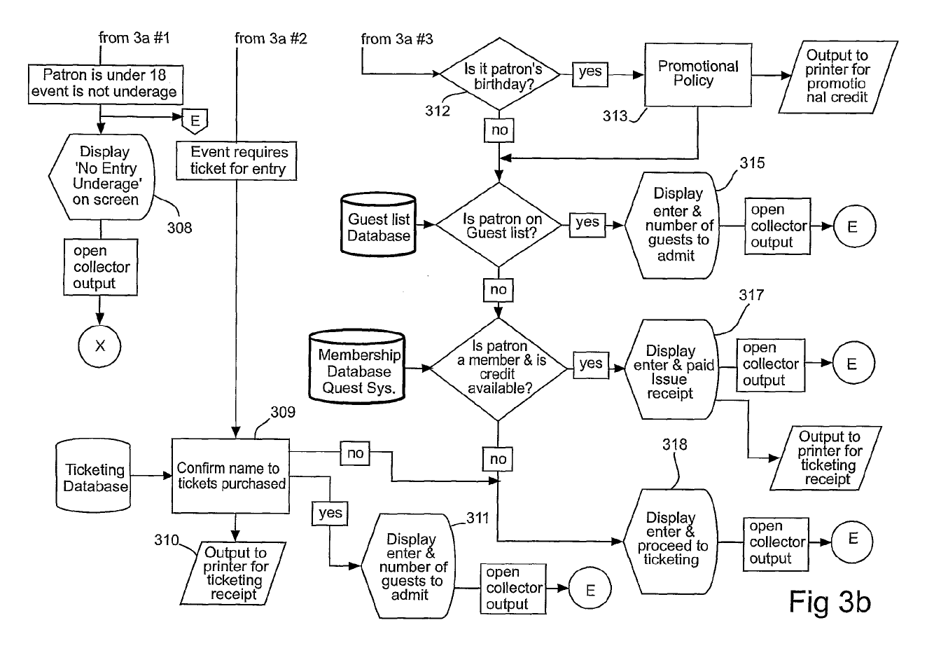

A preferred embodiment of the normal method of identity verification and access control of patrons to a venue will now be described with reference to FIGS. 1, 2 and 3. This is where one of the principal advantages of the present invention becomes more evident, namely, that once a patron has enrolled their fingerprint in the system they need only place their finger on the fingerprint reader 12 of the enrolment terminal in order to gain access to the venue (assuming they are not the banned database) [300] (see FIG. 3a). The fingerprint scan commences automatically [301] and a binary encoded number representational of the fingerprint is generated. The fingerprint matching engine then searches the alpha database [302] for any matching fingerprint template. If no match is found, the fingerprint matching engine then searches the beta database [303] for any matching fingerprint template.

In either case, when a matching fingerprint template is found, the patron's primary key, name and date of birth are loaded into a temporary buffer [304]. The name is moved to the first position in the alpha database, and a historical record is output for storage in a historical log. The name is compared to the banned database list [305] in order to verify that the patron has not been banned from the venue. Bans are typically imposed for a limited period of time, and when lifted the patron's right to gain access to the venue may be restored. Therefore the comparison step at 305 is always with reference to the current date and time [306]. If the patron is currently banned then a “Banned” message appears on the patron screen 22 and the CCO will deny access to the patron. If the patron is not banned, the system checks the event database [307] for any special requirements that may apply to the particular event that is at the venue on the current date arid time [306].

If the event is not underage, and the patron is under 18, the patron screen 22 displays the message “No entry—Underage” [308] and the CCO will deny the patron access to the venue. If the event requires a ticket for entry, the CCO confirms that the name of the patron corresponds to the ticket presented [309]. The enrolment terminal is able to access a ticketing database to obtain this ticketing information. If the name matches, the CCO authorises printing of a ticketing receipt via the printer 42 [310]. Simultaneously the system displays the message “Enter” and the number of guests to be admitted on the patron display screen [311].

If the event is a normal event, and the patron is over 18, the system checks if today is the patron's birthday [312]. If yes, depending on the promotional policy of the club [313], an output is generated to the printer 42 for printing a voucher with some form of promotional credit (eg. one free entry to ticketed event). The club may maintain a guest list database, and the system can be programmed to check if the patron is on a guest list [314]. If yes, the system displays the message “Enter” and the number of guests to be admitted [315]. In addition, the club may also maintain a membership database in which the current paid-up status of the members is maintained. The system can check if the patron is a member and if he/she has any credit available in their member's account [316]. If yes, the system displays “paid” and issues a receipt via the printer 42 [317]. The entry fee is simultaneously deducted from the member's account. If no, the patron is instructed to proceed to ticketing [318].

During the identity verification process that commences automatically as soon as the patron places their finger on the finger print reader 12, the USB camera 24 may be used to capture one or more still images and/or a few seconds of video of the patron during the identity verification process. In this way, a video record of every patron that enters the venue may also be maintained, together with the date and time of entry.

All of the above processing operations during the normal entry process, occur electronically almost instantaneously, so that patrons can be cleared for access to the venue much more rapidly than in the past.

### Review Tools for the Primary Database

Various review tools are provided in the software to enable the manager or licensee of the venue to perform various management functions. For example, the licensee can conduct a search for a particular patron in the primary database 32 held on the central server 34. A ‘Patron Data Search’ page displays search entry boxes for: SURNAME and FIRST NAME, Gender MALE or FEMALE (Drop Down menu—Male, Female, Don't Care) and Membership Number. It also display two additional buttons SEARCH and CANCEL. If the licensee selects the SEARCH button the software searches the primary database (site specific only; if the user is authorised then the search is to be global on the database) for a match. If a match is found it is displayed in a ‘Patron Detail Screen’.

If no match is found then a screen display appears “NO MATCH FOUND”.

The software also has a facility to enable the licensee to review data associated with a particular event. This facility enables the licensee to review, in a filmstrip form, entry of patrons into their venue by date and time. The filmstrip can display ten driver's license face images at a time, five prior to the requested time and five post the requested time. A red vertical line at the centre of the filmstrip designates the requested time with the date and time shown below the red vertical line. If the licensee clicks on a thumbnail with their mouse the review screen is replaced with a ‘patron detail’ screen. The ‘patron detail screen’ displays the following items of record:—
a) Name
b) Date of Birth
c) Entry history (last ten entries)
d) Drivers license image and enlarged driver's license photo
e) BAN history (last ten entries)

The ‘patron detail screen’ has four buttons: PRINT, BAN & RETURN. The BAN function opens the ‘BAN window’ over the ‘patron detail screen’ and inserts the details (name and photo) into the ‘BAN window’. There are user entry boxes for ‘BAN TILL DATE’, ‘BANNED BY’ & ‘REASON FOR BEING BANNED’. The ‘REASON FOR BEING BANNED’ is optional and includes a text box where the licensee can write information for the CCO or manager to read. A check box is displayed adjacent to the ‘REASON FOR BEING BANNED’ text box with the caption ‘Display on Terminal Screen?’. A red warning message appears below the box stating “Caution—if selected this information is displayed on the terminal screen and may be read by the public”.

There is also a CANCEL button and a SAVE button. On selecting CANCEL the screen closes without saving. On selecting the SAVE function the screen of the ‘BAN window’ displays the message: “Updating Server Banned Database” and below that screen displays “Review Banned Database?” with a YES or NO option box. If YES is selected then the ‘Ban Window’ closes and the ‘Banned Database’ screen is displayed. If NO is selected the ‘BAN Window’ closes.

The ‘Banned Database’ screen displays a spreadsheet layout list (alphabetically listed) of all Banned persons that relate to the current site (site exclusive). The Spreadsheet layout typically includes the following cells in a left to right configuration:
a) Tick box for selection
b) Surname and First Name
c) When ban commenced (Date)
d) When ban concludes (Date)
e) Who instigated the ban
f) Description of the reason for the ban

The list displays current banned persons; persons whose ban concludes based on a date calculation do not appear on the current ban list but are removed to the Site Ban Archive Database. The following buttons are also provided: ‘REMOVE BAN’, ‘CREATE NEW BAN’, ‘REVIEW SITE BAN ARCHIVE’ and ‘CLOSE’. To remove a person from the Banned Database 38 the entry TICK BOX is selected and then the REMOVE BAN button is selected. This will transfer the person from the current Banned Database 38 to a Site BAN Archive Database. To place a ban on the entry into the Site, the CREATE NEW BAN button is selected, and the screen is replaced with the ‘Ban Screen’ as described in the preceding section relating to ‘Event Data Review’.

If the licensee wishes to review patrons previously banned from their Site then they can select the REVIEW SITE BAN ARCHIVE button. This opens a new display of all previously banned patrons with the same appearance as the ‘Banned Database’ screen, however it is clearly indicated that the display is NOT CURRENT and is historical archival information only. The CLOSE button is to return the licensee to the ‘Content Screen Page’.

Should a law enforcement officer require a complete patron record for their investigative purposes then an Enhanced Patron Report (EPR) can be requested. Every police officer has a unique number called their registered badge number. This number typically has five digits, no alphas are included, e.g. 01234. Every Police officer also has an email address that includes their badge number e.g. PD01234@police.wa.gov.au. To obtain an EPR from the system a five digit input box (only numbers are allowed to be inputted) for the officer's badge number is included at the bottom of the System Manager Verification Record page. Additionally a send button marked “send email” is provided alongside the five-digit input box. When a five digit number is inserted and the send button is pressed the System Server logs the request and sends a full data verification page to the email address made up from the badge number. A message is displayed: “The requested verification record has been sent to the Police Officers email account.”

Now that preferred embodiments of the system and method of identity verification and access control have been described in detail, it will be apparent that it provides a number of advantages over the prior art, including the following:

(i) It provides a more secure method of verifying the identity of patrons to a venue, as it is next to impossible to counterfeit a fingerprint or other biometric scan;
(ii) It provides a more rapid method of identity verification and access control to a venue, thus helping to significantly reduce patron waiting times; and
(iii) It provides a global solution for efficiently managing identity verification and access control in a multiplicity of licensed premises.

It will be readily apparent to persons skilled in the relevant arts that various modifications and improvements may be made lo the foregoing embodiments, in addition to those already described, without departing from the basic inventive concepts of the present invention. For example, the method and system can be readily modified to provide identity verification and access control of patrons to a sporting venue, eg. a football stadium. Therefore, it will be appreciated that the scope of the invention is not limited to the specific embodiments described.

1. A system of identity verification and access control of patrons to a venue, the system comprising:
a biometric reader for reading an identifying biological characteristic of the patron;
biometric information processing means for generating a unique biometric information key for the patron based on said identifying biological characteristic read by the biometric reader;
a primary database for storing the biometric information keys of newly enrolled patrons and all patrons who have previously attended the venue and been enrolled;
a means to record information indicating that one or more of the biometric information keys belong to patrons that have been banned access to the venue; and
an access data processing means for comparing said biometric information key generated by said biometric information processing means with the biometric information keys stored in said primary database in order to verify both the identity of the patron and whether the patron has been banned access, prior to permitting the patron access to the venue.

2. A system of identity verification and access control in accordance with claim 1, wherein the means to record information indicating that one or more of the biometric keys belong to banned patrons comprises a secondary database in which is stored biometric keys of banned patrons.

3. A system of identity verification and access control in accordance with claim 2, wherein the secondary database contains information regarding the time duration for which each patron is banned and the access data processing means compares the time duration with the time at which the patron attempts to gain access to the venue.

4. A system of identity verification and access control in accordance with claim 1, wherein information regarding identifying documents of a patron is combined with the biometric information key of the patron to form a unique identification record that is stored in the primary database.

4. A system of identity verification and access control in accordance with claim 1, wherein an enrolment terminal is provided at an access point to the venue, the enrolment terminal including the biometric reader and the biometric information processing means.

5. A system of identity verification and access control in accordance with claim 5, wherein the enrolment terminal is in communication with a central server on which is provided the primary database and the access data processing means.

6. A system of identity verification and access control in accordance with claim 6, wherein the enrolment terminal includes a means to input information regarding a patron along with the read biological characteristic of the patron to enrol the patron in the primary database.

7. A system of identity verification and access control in accordance with claim 7, wherein the means to input information includes a first display on which can be displayed questions for the patron to obtain said information regarding the patron.

8. A system of identity verification and access control in accordance with claim 8, wherein the first display displays information including the results of
whether a patron's identity has been verified and whether the patron has been banned access to the venue can be displayed.

10. A system of identity verification and access control in accordance with claim 9, wherein the enrolment terminal includes a second display for displaying information to a crowd control officer.

11. A system of identity verification and access control in accordance with claim 5, wherein the enrolment terminal includes a document scanning means to scan the identifying documents of a patron such that the scanned information is combined with the biometric information key from the biometric reader and transmitted to the central server as the unique identification record.

12. A system of identity verification and access control in accordance with claim 1, wherein the biometric reader comprises a fingerprint scanner.

13. A system of identity verification and access control in accordance with claim 12, wherein the scanned fingerprint is converted into a binary number representing the unique characteristics of the ridges and meridian points of the fingerprint, the binary number forming the biometric information key.

14. A system of identity verification and access control in accordance with claim 1, wherein a means to capture image information for each patron at the time of entry is provided.

15. A system of identity verification and access control in accordance with claim 14, wherein the means to capture image information comprises a camera connected to the enrolment terminal, the camera being arranged to take a picture of each patron attempting to enter the venue via the enrolment terminal.

16. A system of identity verification and access control in accordance with claim 14, wherein a review tool is provided, the review tool allowing an authorised person to review the image information of patrons entering the venue within a particular time frame and the unique identification records of those patrons stored in the primary database.

17. A system of identity verification and access control in accordance with claim 16, wherein the review tool comprises software on the central server.

18. A system of identity verification and access control in accordance with claim 17, wherein the review tool includes means to select one or more of the unique identification records of those patrons entering the venue within the time frame for inclusion in the secondary database.

19. A system of identity verification and access control in accordance with claim 18, wherein the review tool includes means to add information regarding the time duration of the ban and reason for the ban to the secondary database.

20. A system of identity verification and access control in accordance with claim 1, wherein the primary database comprises: an alpha database in which are stored the biometric information keys of a selected number of the most recent patrons to enter the venue; and a beta database in which are stored the biometric information keys of all patrons entering the venue;
wherein the access data processing means compares first the generated biometric information key generated with the biometric information keys stored in said alpha database and if no match is found, compares the generated biometric information key generated with the biometric information keys stored in said beta database.

21. A system of identity verification and access control in accordance with claim 1 wherein an event database is provided in which is stored information specific to an event, and the access data processing means compares the information contained in the unique identification record of a patron with the event database information to determine whether access to the current event is permitted.

22. A system of identity verification and access control in accordance with claim 21, wherein the stored information in the event database includes age restrictions on the event and the access data processing means compares age information stored in the unique identification record of a patron with the age restriction.

23. A system of identity verification and access control in accordance with claim 1, wherein a means is provided to store membership information in the primary database for enrolled patrons.

24. A system of identity verification and access control in accordance with claim 5, wherein a means is provided to display survey questions on the enrolment terminal and store the patrons answers to the survey questions along with information contained in the primary database about the patron.

25. A system of identity verification and access control in accordance with claim 5, wherein a means is provided to search the primary database based on information contained in the primary database other than the biometric information key.

26. A method of identity verification and access control of patrons to a venue, the method comprising the steps of:
reading an identifying biological characteristic of a patron;
generating a unique biometric information key for the patron based on said identifying biological characteristic;
storing the biometric information keys of newly enrolled patrons and all patrons who have previously attended the venue and been enrolled;
storing information indicating that one or more of the biometric information keys belongs to a patron that has been banned access to the venue;
comparing said unique biometric information key with the stored biometric information keys in order to verify both the identity of the patron and whether the patron is banned access, prior to permitting the patron access to the venue.

27. A method of identity verification and access control in accordance with claim 26, wherein the biometric keys belonging to banned patrons are stored in a secondary database.

28. A method of identity verification and access control in accordance with claim 27, wherein information regarding the time duration for which each patron is banned is stored in the secondary database and the access data processing means compares the time duration with the time at which the patron attempts to gain access to the venue.

29. A method of identity verification and access control in accordance with claim 26, wherein information regarding identifying documents of a patron is combined with the biometric information key of the patron to form a unique identification record that is stored in the primary database.

30. A method of identity verification and access control in accordance claim 26, wherein an enrolment terminal is provided at an access point to the venue and the enrolment terminal communicates with a central server on which is provided the primary database and access data processing means.

31. A method of identity verification and access, control in accordance with claim 30, wherein the method includes the steps of displaying on a first display on the enrolment terminal, information including the results of whether a patron's identity has been verified and whether the patron has been banned access to the venue.

32. A method of identity verification and access control in accordance with claim 26, wherein the step of reading biometric information comprises scanning fingerprints.

33. A method of identity verification and access control in accordance with claim 32, wherein the biometric information key is formed by converting the scanned fingerprint into a binary number representing the unique characteristics of the ridges and meridian points of the fingerprint.

34. A method of identity verification and access control in accordance with claim 26, wherein the method includes the step of capturing image information for each patron at the time of entry.

35. A method of identity verification and access control in accordance with claim 34, wherein a camera is used to capture the image information.

36. A method of identity verification and access control in accordance with claim 26, wherein the method includes:
comparing the generated biometric information key generated with the biometric information keys stored in an alpha database, in which are stored the biometric information keys of a selected number of the most recent patrons to enter the venue; and
if no match is found, comparing the generated biometric information key generated with the biometric information keys stored in a beta database in which are stored the biometric information keys of all patrons entering the venue.

37. A method of identity verification and access control in accordance with claim 26 including the step of storing information specific to an event in an event database and comparing the information contained in the unique identification record of a patron with the event database information to determine whether access to the current event is permitted.

38. A method of identity verification and access control in accordance with claim 26, wherein membership information is stored in the primary database for enrolled patrons and this membership information is accessed by the access data processing means when the patron enters the venue via the enrolment terminal.

39. A method of identity verification and access control in accordance with claim 30, wherein survey questions are displayed on the enrolment terminal and the answers to the survey questions provided by the patron are stored along with information contained in the primary database about the patron.
